(19) United States
(12) Patent Application Publication
(10) Pub. No.: US 2004/0072696 A1
(43) Pub. Date: Apr. 15, 2004

(54) Invert emulsion fluids having negative alkalinity

(75) Inventor: Arvind D. Patel, Houston, TX (US)

Correspondence Address: STEPHEN H. CAGLE, HOWREY SIMON ARNOLD & WHITE LLP, 750 BERING DRIVE, HOUSTON, TX, 77057, US

(73) Assignee: M-I LLC., Houston, TX

(21) Appl. No.: 10/441,270

(22) Filed: May 19, 2003

Related U.S. Application Data
(63) Continuation of application No. 09/520,303, filed on Mar. 7, 2000, now abandoned.
Application No. 09/520,303 is a continuation of application No. 09/190,783, filed on Nov. 12, 1998, now abandoned.
Application No. 09/190,783 is a continuation-in-part of application No. 09/130,914, filed on Aug. 7, 1998, now Pat. No. 5,977,031.
Application No. 09/130,914 is a continuation-in-part of application No. 09/043,868, filed on Mar. 20, 1998, now Pat. No. 5,985,800.
Application No. 09/130,914 is a continuation-in-part of application No. 08/862,198, filed on May 23, 1997, now Pat. No. 5,905,061.
(60) Provisional application No. 60/047,543, filed on May 23, 1997.
(60) Provisional application No. 60/023,043, filed on Aug. 2, 1996.

(51) Int. Cl. C09K 7/06

(52) U.S. Cl. 507/100

(57) ABSTRACT

An invert emulsion suitable for drilling subterranean wells, in particular oil and gas wells is disclosed which has negative alkalinity and includes an oleaginous phase, and a non-oleaginous phase and an emulsifying agent which stabilizes the invert emulsion under conditions of negative alkalinity. The practice of the present invention permits the formulation of drilling fluids which are absent an alkaline reserve and yet are suitable for drilling oil and gas wells.

### BACKGROUND OF THE INVENTION

1. Field of the Invention

The present invention is generally directed to an invert emulsion drilling fluid or mud suitable for drilling subterranean wells. More particularly, the present invention relates to an invert emulsion possessing negative alkalinity as is defined herein.

2. Background

Invert emulsion fluids, i.e. emulsions in which the non-oleaginous fluid is the discontinuous phase and the oleaginous fluid is the continuous phase, are employed in drilling processes for the development of oil or gas sources, as well as, in geothermal drilling, water drilling, geoscientific drilling and mine drilling. Specifically, the invert emulsion fluids are conventionally utilized for such purposes as providing stability to the drilled hole, forming a thin filter cake, lubricating the drilling bore and the downhole area and assembly, and penetrating salt beds without sloughing or enlargement of the drilled hole.

Oil-based drilling fluids are generally used in the form of invert emulsion muds. An invert emulsion mud consists of three-phases: an oleaginous phase, a non-oleaginous phase and a finely divided particle phase. Also typically included are emulsifiers and emulsifier systems, weighting agents, fluid loss additives, viscosity regulators and the like, for stabilizing the system as a whole and for establishing the desired performance properties. Full particulars can be found, for example, in the Article by P. A. Boyd et al entitled “New Base Oil Used in Low-Toxicity Oil Muds” in the Journal of Petroleum Technology, 1985, 137 to 142 and in the Article by R. B. Bennet entitled “New Drilling Fluid Technology-Mineral Oil Mud” in Journal of Petroleum Technology, 1984, 975 to 981 and the literature cited therein.

The components of the invert emulsion fluids include an oleaginous liquid such as hydrocarbon oil which serves as a continuous phase, a non-oleaginous liquid such as water or brine solution that serves as a discontinuous phase, and an emulsifying agent. As used herein, emulsifying agent and surfactant are used interchangeably. The emulsifying agent serves to lower the interfacial tension of the liquids so that the non-oleaginous liquid may form a stable dispersion of fine droplets in the oleaginous liquid. A full description of such invert emulsions may be found in Composition and Properties of Drilling and Completion Fluids, 5th Edition, H. C. H. Darley, George R. Gray, Gulf Publishing Company, 1988, pp. 328-332, the contents of which are hereby incorporated by reference.

Lime or other alkaline materials are typically added to conventional invert emulsion drilling fluids and muds to maintain a reserve alkalinity. See, for example, API Bulletin RP 13B-2, 1990, p. 22, which describes a standard test for determining excess lime in drilling mud. See also, for example, U.S. Pat. No. 5,254,531 which employs lime along with an ester oil, a fatty acid, and an amine and EP 271943 which employs lime along with oil, water, and an ethoxylated amine. The generally accepted role of the reserve alkalinity is to help maintain the viscosity and stability of the invert emulsion. This is especially important in areas in which acidic gases such as CO₂ or H₂S are encountered during drilling. Absent an alkaline reserve, acidic gases will weaken stability and viscosity of conventional invert emulsion fluids to the point of failure. That is to say the invert emulsion becomes so unstable that the oil wet solids become water wet and the phases of the invert emulsion “flip” thus rendering the invert emulsion fluid not suitable for use as a drilling fluid. One of skill in the art should understand that due to the high cost of removing and disposing of the flipped mud from a borehole, the formation of flip mud is very undesirable. Further because the beneficial properties of the drilling fluid have been lost, (i.e. viscosity, pumpability and the ability to suspend particles) the likelihood of a blowout is greatly increased. Thus, one of ordinary skill in the art should understand that the maintenance of a alkalinity reserve is critical to the use of conventional invert emulsion drilling fluids and muds.

### SUMMARY OF THE INVENTION

The present invention is generally directed to an invert emulsion drilling fluid that is formulated so as to have a negative alkalinity as is defined herein. Such an illustrative fluid should include: an oleaginous phase; a non-oleaginous phase and an emulsifying agent capable of stabilizing the invert emulsion under conditions of negative alkalinity. The oleaginous phase may be mineral oil, synthetic oils, poly-alpha olefins, or esters of C₁ to C₁₂ alcohols and a C₈ to C₂₄ monocarboxylic acid, and preferably the ester is selected from C₁ to C₁₂ alkyl alcohol esters of oleic acid, C₁ to C₁₂ alkyl alcohol esters of myristic acid, C₁ to C₁₂ alkyl alcohol ester of coco fatty acid, and mixtures thereof. The emulsifying agent should be capable of stabilizing the invert emulsion in the absence of an alkali reserve. That is to say the addition of an aqueous acidic solution to the invert emulsion should not cause the invert emulsion to break. The non-oleaginous phase should preferably have an hydroxide ion concentration of less than 1×10⁻⁸ moles per liter. Optionally the illustrative drilling fluid may include a weighting agent selected from barite, calcite, mullite, gallena, manganese oxides, iron oxides, or combinations thereof. The non-oleaginous phase of the drilling fluid is preferably selected from aqueous solutions including fresh water, sea water, brine, aqueous solutions containing water soluble organic salts, water soluble alcohols or water soluble glycols or combinations thereof.

Also encompassed within the present invention is a mineral-oil free invert emulsion drilling fluid which includes an oleaginous phase, a non-oleaginous phase and an emulsifying agent such that the mineral oil free invert emulsion drilling fluid has negative alkalinity. The oleaginous phase of this illustrative embodiment may comprise substantially of esters of C₁-C₁₂ alcohols and C₈-C₂₄ monocarboxylic acids, and preferably the ester is selected from C₁ to C₁₂ alkyl alcohol esters of oleic acid, C₁ to C₁₂ alkyl alcohol esters of myristic acid, C₁ to C₁₂ alkyl alcohol ester of coco fatty acid, and mixtures thereof. The non-oleaginous phase is preferably selected from fresh water, sea water, brine, aqueous solutions containing water soluble organic salts, water soluble alcohols or water soluble glycols or combinations thereof. The emulsifying agent should be in sufficient amounts so as to stabilize an invert emulsion under conditions of negative alkalinity as is defined herein.

Another encompassed embodiment of the present invention is an alkali reserve free invert emulsion drilling fluid that is formulated so that the drilling fluid includes: an oleaginous phase which may substantially composed of esters of C₁ to C₁₂ alcohols and a C₈ to C₂₄ monocarboxylic acid; a non-oleaginous phase and a emulsifying agent capable of stabilizing the invert emulsion absent an alkali reserve.

Further encompassed by the present invention is an invert emulsion drilling fluid of the present invention the formulation includes: an oleaginous phase comprising substantially of esters of C₁ to C₁₂ alcohols and a C₈ to C₂₄ monocarboxylic acid; a non-oleaginous phase; and an emulsifying agent capable of stabilizing the invert emulsion in the absence of an alkali reserve and wherein said fluid is absent an alkaline reserve.

Also encompassed within the scope of the present invention are the methods of making and using the invert emulsion drilling fluids disclosed herein. Thus one illustrative method embodiment of the present invention includes a method of drilling a subterranean well with an invert emulsion drilling fluid including: formulating a negative alkalinity invert emulsion drilling fluid such that the drilling fluid includes, an oleaginous phase, preferably comprising substantially of esters of C₁ to C₁₂ alcohols and a C₈ to C₂₄ monocarboxylic acid; a non-oleaginous phase; and an emulsifying agent which is capable of stabilizing the invert emulsion in the absence of an alkali reserve; and drilling said well with said invert emulsion drilling fluid.

### DESCRIPTION OF ILLUSTRATIVE EMBODIMENTS

As used herein, the term “invert emulsion” is an emulsion in which a non-oleaginous fluid is the discontinuous phase and an oleaginous fluid is the continuous phase. The novel invert emulsion fluids of the present invention are useful in a similar manner as conventional invert emulsion fluids which includes utility in preparation for drilling, drilling, completing and working over subterranean wells such as oil and gas wells. Such methods of use of conventional inverse emulsion fluids are described in, for example, Composition and Properties of Drilling and Completion Fluids, 5th Edition, H. C. H. Darley, George R. Gray, Gulf Publishing Company, 1988, the contents which are incorporated by reference, as well as, U.S. Pat. No. 5,254,531 and EP 271943 which are incorporated by reference. One of skill in the art should know and understand the standard methods of determining if an invert emulsion has been formed. Examples of two such tests for the formation of an invert emulsion include the Invert Emulsion Test as disclosed herein and the measurement of the electrical stability of the invert emulsion.

As used herein the term “alkalinity” means a presence of an alkaline reserve as is measured using the methods setforth in API Bulletin RP 13B-2, 1990, which describes a standard test for determining excess lime in drilling mud, the contents of which are hereby incorporated by reference.

As used herein the terms “negative alkalinity” or “negative alkaline reserve” means an the absence of an alkaline reserve or that condition of the invert emulsion which would require the addition of alkaline reserve material so as to establish a measurable value of alkalinity. That is to say one of skill in the art would consider the invert emulsion to be acidic in nature and thus require the addition of sufficient alkaline reserve material to neutralize any acidic components present as well to establish the desired alkaline reserve. Alternatively negative alkalinity or negative alkaline reserve may be considered as being that state of an invert emulsion drilling fluid in which the non-oleaginous phase has a hydroxide ion (OH⁻) concentration of less than 1×10⁻⁷ moles per liter and more preferably a hydroxide ion concentration of less than 1×10⁻⁸ moles per liter. One of ordinary skill in the art should understand that a hydroxide ion concentration of 1×10⁻⁸ may be expressed as a pOH value of 8 which in aqueous solution corresponds to a pH of 5. The hydroxide ion concentration may be tested by separating the two phases, for example by allowing the emulsion to separate over the course of several days to weeks, and then carefully measuring the hydroxide ion concentration of the non-oleaginous phase by conventional means which should be known to one of skill in the art.

As used herein the term “oleaginous liquid” means an oil which is a liquid at 25° C. and immiscible with water. Oleaginous liquids typically include substances such as diesel oil, mineral oil, synthetic oil, ester oils, glycerides of fatty acids, aliphatic esters, aliphatic ethers, aliphatic acetals, or other such hydrocarbons and combinations of these fluids. In one illustrative embodiment of this invention the oleaginous liquid is an ester material which provides environmental compatibility to the overall drilling fluid. Such esters are described in greater detail below.

The amount of oleaginous liquid in the invert emulsion fluid may vary depending upon the particular oleaginous fluid used, the particular non-oleaginous fluid used, and the particular application in which the invert emulsion fluid is to be employed. However, generally the amount of oleaginous liquid must be sufficient to form a stable emulsion when utilized as the continuous phase. Typically, the amount of oleaginous liquid is at least about 30, preferably at least about 40, more preferably at least about 50 percent by volume of the total fluid.

As used herein, the term “non-oleaginous liquid” means any substance which is a liquid at 25° C. and which is not an oleaginous liquid as defined above. Non-oleaginous liquids are immiscible with oleaginous liquids but capable of forming emulsions therewith. Typical non-oleaginous liquids include aqueous substances such as fresh water, sea water, brine containing inorganic or organic dissolved salts, aqueous solutions containing water-miscible organic compounds and mixtures of these. In one illustrative embodiment the non-oleaginous fluid is brine solution including inorganic salts such as calcium halide salts, zinc halide salts, alkali metal halide salts and the like.

The amount of non-oleaginous liquid in the invert emulsion fluid may vary depending upon the particular non-oleaginous fluid used and the particular application in which the invert emulsion fluid is to be employed. Typically, the amount of non-oleaginous liquid is at least about 1, preferably at least about 3, more preferably at least about 5 percent by volume of the total fluid. Correspondingly, the amount should not be so great that it cannot be dispersed in the oleaginous phase. Therefore, typically the amount of non-oleaginous liquid is less than about 90, preferably less than about 80, more preferably less than about 70 percent by volume of the total fluid.

As the term is used herein, the term “surfactant” and “emulsifier” or “emulsifying agent” are used interchangeably to indicate that component of the invert emulsion drilling fluid that stabilizes the invert emulsion. One of ordinary skill in the art should appreciate that such a compound acts at the interface of the oleaginous and the non-oleaginous fluids and lowers the differences in surface tension between the two layers. In the present invention it is important that the emulsifying agent is not adversely affected by the presence of acid in the non-oleaginous component of the invert emulsion. The ability of any particular emulsifying agent to stabilize the invert emulsion can be tested by using the invert emulsion test disclosed below. In addition if the emulsifying agent is to be useful in the formulation of a drilling fluid, the emulsifier should be thermally stable. That is to say, the emulsifier must not break down or chemically degrade upon heating to temperatures typically found in a downhole environment. This may be tested by heat aging the emulsifier as is done in the Examples. A suitable emulsifier within the scope of the present invention should be capable of stabilizing the invert emulsion under conditions of negative alkalinity and heat aging.

In one preferred embodiment of the present invention, the emulsifying agent is a combination of an amidoamine primary emulsifier, such as a diethylene triamine fatty acid, commercially available as Ecogreen-P from M-I L.L.C., a fatty acid based secondary emulsifier, such as a tall oil fatty acid, commercially available as Ecogreen-S from M-I L.L.C. and a polymeric fluid loss control agent, such as a oil dispersible polystyrene butdiene copolymer, commercially available as Ecogreen-F from M-I L.L.C. One of skill in the art should understand that the selection of this combination of specific emulsifiers is but one of many possible combinations of emulsifiers having similar properties and characteristics. The process of testing any particular selection of a suitable emulsifier or emulsifier package may depend upon the conditions and components of the drilling fluids and thus the use of the Invert Emulsion test disclosed herein should be utilized.

In another embodiment of the present invention the emulsifying agent is a protonated amine. As used herein, the term “amine” refers to compounds having the structure R—NH₂ wherein R represents a C₁₂-C₂₂ alkyl group, a C₁₂-C₂₂ alkenyl group, a C₃-C₈ cycloalkyl group substituted with a C₉-C₁₄ alkyl or alkenyl group, or a C₉-C₁₄ alkyl or alkenyl group substituted with a C₃-C₈ cycloalkyl group. Preferable R groups include straight or branched dodecyl, tridecyl, tetradecyl, pentadecyl, hexadecyl, heptadecyl, octadecyl, nodecyl, eicosyl, heneicosyl, docosyl, as well as, mixtures and unsaturated derivatives thereof. Preferable unsaturated derivatives include soyaalkylamine (Armeen S™ available from Akzo Chemicals Inc.) and tallowalkylamine (Armeen T™ available from Akzo Chemicals Inc.). Many of the other above amines are also commercially available from Akzo Chemicals Inc. under the tradename Armeen™. Other oleophillic amines may be used in the practice of the present invention so long as their protonated salt stabilizes the invert emulsion. Such amines can be determined by one of ordinary skill in the art by trial and error testing of the protonated amine and its ability to form a stable invert emulsion under conditions of negative alkalinity.

The aforementioned amines of the formula R—NH₂ are protonated for use in the present invention. The term “protonated” means that the amine is converted to the structure R—N⁺—H₃ B⁻. Typically, such protonation occurs due to reaction of the amine with a water-soluble acid as discussed below. Generally, the type of counter-ion, B⁻, is not particularly critical so long as it does not adversely affect the performance and characteristics of the resulting emulsion as is disclosed herein. Examples of the counter-ion include the conjugate bases of the acids described below.

The protonated amine functions in the instant invention as a surfactant to lower the interfacial tension of the liquids so that the non-oleaginous liquid may form a stable dispersion of fine droplets in the oleaginous liquid (i.e. form an invert emulsion). Therefore, the amount of protonated amine should be sufficient to enable the formation of an invert emulsion. While this amount may vary depending upon the nature and amount of the oleaginous liquid and non-oleaginous liquid, typically the amount of protonated amine is at least about 0.1, preferably at least about 5, more preferably at least about 10 percent by weight to volume of the total fluid. Correspondingly, the amount should not be so great that the protonated amine interferes with the stability of the invert emulsion fluid or the performance of the invert emulsion as a drilling fluid.

As used above, the term “acid” refers to water-soluble, i.e. at least 10 percent by volume of the acid dissolves in water, compounds which form “acidic solutions”. A solution is considered to be an “acidic solution” if it is capable of protonating the amine and render a stable non-oleaginous fluid in oleaginous fluid emulsion. The term acid refers to both inorganic acids such as sulfuric, nitric, hydrofluoric, hydrochloric and phosphoric acid and organic acids such as citric, acetic, formic, benzoic, salicyclic, oxalic, glycolic, lactic, glutaric acid, halogenated acetic acids, boric acid, organosulfonic acids, organophosphoric acids and the like. Fatty acids such as oleic, palmitic, and stearic acid are less desirable as acids because such acids are not water-soluble. Compounds that generate acidic solutions upon dissolution in water are also considered “acids” as the term is used herein. For example such acids may include, acetic anhydride, hydrolyzable esters, hydrolyzable organosulfonic acid derivatives, hydrolyzable organophosphoric acid derivatives, phosphorus trihalide, phosphorous oxyhalide, acidic metal salts, sulfur dioxide, nitrogen oxides, carbon dioxide, and similar such compounds. Thus in one embodiment, the acidic solution is formed by the dissolution of an acidic metal salt in water. That is to say upon dissolution of the metal salt, a sufficient concentration of protons are produced the resulting solution is capable of protonating the amine and render a stable non-oleaginous fluid in oleaginous fluid emulsion. In another embodiment the acidic solution is a brine formed by the dissolution of a neutral metal salt and an acidic metal salt in water. In yet another embodiment, an acidic solution may be formed by the dissolution of a acid compound and a neutral salt.

When an amine surfactant is present, the amount of acid must be sufficient to protonate a majority of the amine thus making it capable of stabilizing the invert emulsion under conditions of negative alkalinity. As one skilled in the art should appreciate, the amount of acid will necessarily vary with the strength of the acid and the particular amine to be protonated. Nevertheless, one skilled in the art having the benefit of this specification may readily determine the necessary amount of acid via routine experimentation by systematically adjusting the amount and type of acid to be used with any particular amine and then testing to see if the resulting protonated amine is capable of forming and stabilizing an invert emulsion.

As used herein the term “ester” has been used in relation to the oleaginous fluid component of the invert emulsions of the present invention. Such use of the term “ester” should be broadly construed to include all esters that are suitable for use in drilling fluids. In one preferred embodiment, the term “ester” generally includes esters formed in the esterification reaction of a C₁ to C₁₂ alcohol and a C₈ to C₂₄ monocarboxylic acid. Optionally the ester may be the product of the esterification reaction between a C₁ to C₁₂ alcohol and a C₄ to C₁₂ polycarboxylic acid. An illustrative example of a poly-functional carboxylic acid may be succinic acid, which would form a di-ester in the esterification reaction with a C₁ to C₁₂ alcohol.

The esters suitable for use in the present invention should be oleaginous and capable of forming invert emulsion with water or other aqueous based fluids. In addition the esters which may be utilized in the present invention may be broadly selected from esters formed from C₁-C₁₂ alcohols and mono-functional or poly-functional carboxylic acids, so long as the ester flow and can be pumped at temperatures in the range from about 0° to about 25° C. Such esters should also be selected so that the flash point of the ester does not create a combustion hazard on the drilling rig. Therefore the esters of the present invention should be selected so as to have a flash point greater than about 100° F. and preferably a flash point greater than about 130° F. In one preferred embodiment the flash point of the ester is in the range from about 125° F. to about 150° F. Another property of the esters of the present invention is that of viscosity. The ester should be selected so that it has a viscosity that is suitable for use in a drilling fluid. Preferably the viscosity should be less than about 15 centistokes at about 100° C. and more preferably less than about 10 centistokes at about 100° C.

Esters which may be utilized in the practice of the present invention do not show the same in-use behavior as the ester based drilling fluids reported prior to the present invention. In practical application, the esters of C₁ to C₁₂ alcohol and C₈ to C₂₄ monocarboxylic acid undergo hydrolysis in the presence of hydroxide ion (OH⁻), resulting in the formation of the corresponding alcohol and carboxylic acid. The formation of acid in conventional ester based drilling fluid is of great concern because such fluids have an alkaline reserve, which is chemically neutralized by the acids thus destabilizing the invert emulsion drilling fluid. Further the acid in the presence of lime may form a calcium soap, which further promotes the adverse effect on rheology of the invert emulsion. The hydrolysis reaction is reported to be the primary reason for the careful selection of esters that are either thermodynamically or kinetically stable with regard to the hydrolysis reaction. Another reported approach has been the addition of amine compounds in combination with a mild alkaline reserve. The role of the amine compound is to preferentially react with the acids generated by the hydrolysis reaction. Thus, the amine compound serves as a “buffer” for the alkaline reserve and prevents it's consumption by the fatty acids generated by the hydrolysis reaction.

The above is in contrast with the teachings of the present invention in which an invert emulsion drilling fluid may be based on ester oils despite the difficulties of hydrolysis inherent in the use of ester based materials in a conventional ester based invert emulsion drilling fluid. In particular it is believed that the negative alkalinity of the invert emulsion drilling fluids of the present invention greatly reduces the hydrolysis reaction. Further the presence of carboxylic acid has no deleterious effect on the protonated amine surfactant, which stabilizes the invert emulsion. Thus rather than reducing the rate of hydrolysis by the careful selection of the ester or providing an alkaline reserve “buffer”, the present invention greatly reduces the hydrolysis of the ester by substantially eliminating the source of hydroxide ion, i.e. the alkaline reserve.

As already stated, the choice of esters which may be utilized in the invention disclosed herein may be selected from the general class of reaction products of monofunctional carboxylic acids with monofunctional alcohols. In addition, however, it is intended in accordance with the invention to at least predominantly to use C₈-C₂₄ carboxylic acids. The carboxylic acids may be derived from unbranched or branched hydrocarbon chains, preferably linear chains and may be saturated, monounsaturated or polyunsatutrated. Selected individual esters formed from an alkyl monocarboxylic acid and a monoalcohol can be used as the ester oil in accordance with the invention. So far as the rheology of the system is concerned and/or for reasons of availability, it is frequently desirable to use esters from acid mixtures. This is of importance so far as meeting the above-stated specifications of the two-classes for preferred ester oils is concerned.

Economically the selection of the ester utilized in the present invention becomes very important because the present invention allows the use of primary alcohol esters and secondary alcohol esters, which previously had a limited application due to their rapid rate of hydrolysis in the presence of hydroxide ion. Thus the selection of the alcohol portion of the esters utilized in the present invention may be based on economic considerations of cost and availability and not necessarily on the rate of hydrolysis of the ester. In view of the teaching of the present disclosure, one of skill in the art should understand that the broad group of C₁-C₁₂ alcohols includes alcohols selected from: primary alkyl alcohols such as for example, methanol, ethanol, n-propanol, n-butanol, n-pentanol, and the like, branched primary alcohols such as 2-methylpropan-1-ol. 2,2-dimethylpropan-1-ol, 2,2-dimethylbutan-1-ol, 3,3-dimethyl butan-1-ol and the like; secondary alkyl alcohols and tertiary alkyl alcohols as well as unsaturated alcohols which previously have not be used due to the problems with hydrolysis due to the presence of an alkaline reserve.

Upon review of the present disclosure, one of skill in the art should appreciate that esters of the present invention may be preferably selected from: C₁ to C₁₂ alkyl alcohol esters of oleic acid, C₁ to C₁₂ alkyl alcohol esters of myristic acid, C₁ to C₁₂ alkyl alcohol ester of coco fatty acid, combinations and mixtures thereof. More preferably, esters, which afford especially high economic cost savings and thus are more preferred include: oleate methyl ester, isopropyl meristate ester, methyl ester of coco fatty acid. However the selection of any particular ester, as previously noted may depend upon availability and economic considerations such as cost.

Various supplemental surfactants and wetting agents conventionally used in invert emulsion fluids may optionally be incorporated in the fluids of this invention. Such surfactants are, for example, fatty acids, soaps of fatty acids, amido amines, polyamides, polyamines, oleate esters, imidazoline derivatives, oxidized crude tall oil, organic phosphate esters, alkyl aromatic sulfates and sulfonates, as well as, mixtures of the above. Generally, such surfactants are employed in an amount, which does not interfere with the fluids of this invention being used as drilling fluids.

Viscosifying agents, for example, organophillic clays, may optionally be employed in the invert drilling fluid compositions of the present invention. Usually, other viscosifying agents, such as oil soluble polymers, polyamide resins, polycarboxylic acids and fatty acid soaps may also be employed. The amount of viscosifying agent used in the composition will necessarily vary depending upon the end use of the composition. Usually such viscosifying agents are employed in an amount, which is at least about 0.1, preferably at least about 2, more preferably at least about 5 percent, by weight to volume of the total fluid. VG-69™ and VG-PLUS™ are organoclay materials and Versa HRP™ is a polyamide resin material manufactured and distributed by M-I L.L.C. which are suitable viscosifying agents.

The invert emulsion drilling fluids of this invention may optionally contain a weight material. The quantity and nature of the weight material depends upon the desired density and viscosity of the final composition. The preferred weight materials include, but are not limited to, barite, calcite, mullite, gallena, manganese oxides, iron oxides, mixtures of these and the like. The weight material is typically added in order to obtain a drilling fluid density of less than about 24, preferably less than about 21, and most preferably less than about 19.5 pounds per gallon.

Fluid loss control agents such as modified lignite, polymers, oxidized asphalt and gilsonite may also be added to the invert drilling fluids of this invention. Usually such fluid loss control agents are employed in an amount, which is at least about 0.1, preferably at least about 1, more preferably at least about 5 percent, by weight to volume of the total fluid.

The method of preparing the drilling fluids of the present invention is not particularly critical so long as an invert emulsion is formed under conditions of negative alkalinity. Generally, the components may be mixed together in any order under agitation condition. When an amine surfactant is used, it is important that the amine surfactant be protonated for the formation of invert emulsion with the oleaginous and non-oleaginous fluids. A representative method of preparing said invert emulsion fluids comprises mixing an appropriate quantity of oleaginous fluid and an appropriate quantity of surfactant together with continuous, mild agitation. A non-oleaginous fluid is then added while mixing until an invert emulsion is formed. If weight material, such as those described below, are to be added, then the weight material is typically added after the invert emulsion fluid is formed.

One skilled in the art may readily identify whether using the following test has used the appropriate ingredients and amounts to form an invert emulsion:

INVERT EMULSION TEST: A small portion of the emulsion is placed in a beaker, which contains an oleaginous fluid. If the emulsion is an invert emulsion, the small portion of the emulsion will disperse in the oleaginous fluid. Visual inspection will determine if it has so dispersed.

Alternatively, the electrical stability of the invert emulsion may be tested using a typical emulsion stability tester. Generally the voltage applied across two electrodes is increased until the emulsion breaks and a surge of current flows between the two electrodes. The voltage required to break the emulsion is a common measure of the stability of such an emulsion. Other tests are described on page 166 of the book, Composition and Properties of Drilling and Completion Fluids, 5th Edition, H. C. H. Darley and George Gray, Gulf Publishing Company, 1988, the contents of which are hereby incorporated by reference.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

The following examples are submitted for the purpose of illustrating the performance characteristics of the drilling fluid compositions of this invention. These tests were conducted substantially in accordance with the procedures in API Bulletin RP 13B-2, 1990, which is incorporated herein by reference. The following abbreviations may be used in describing the results of experimentation:

“E.S.” is electrical stability of the emulsion as measured by the test described in Composition and Properties of Drilling and Completion Fluids, 5th Edition, H. C. H. Darley, George R. Gray, Gulf Publishing Company, 1988, pp. 116, the contents of which are hereby incorporated by reference. Generally, the higher the number, the more stable the emulsion.

“PV” is plastic viscosity which is one variable used in the calculation of viscosity characteristics of a drilling fluid, measured in centipoise (cp) units.

“YP” is yield point which is another variable used in the calculation of viscosity characteristics of drilling fluids, measured in pounds per 100 square feet (lb/100 ft²).

“AV” is apparent viscosity, which is another variable, used in the calculation of viscosity characteristic of drilling fluid, measured in centipoise (cp) units.

“GELS” is a measure of the suspending characteristics, or the thixotropic properties of a drilling fluid, measured in pounds per 100 square feet (lb/100 ft²).

“API F.L.” is the term used for API filtrate loss in milliliters (ml).

“HTHP” is the term used for high temperature high pressure fluid loss at 200° F., 2 measured in milliliters (ml) according to API bulletin RP 13 B-2, 1990.

As used in the formulation of the drilling fluids illustrated in the following example the following component names are intended to mean the following:

Finagreen BDMF® is fatty acid ester distributed by FINA chemicals.

Ecogreen-P® is a primary surfactant package distributed by M-I L.L.C.

Ecogreen-S® is a secondary surfactant package distributed by M-I L.L.C.

Ecogreen-F® is a polymeric fluid loss control agent distributed by M-I L.L.C.

isopropyl meristate ester is fatty acid ester obtained from R I T A chemicals.

coco fatty acid methyl ester is obtained from FINA Chemicals.

Oleate methyl ester was obtained from FINA Chemicals.

VERSALIG is fluid loss control agent distributed by M-I L.L.C.

NOVATHIN is surfactant distributed by M-I L.L.C.

EMI-545 is a protonated amine acetate surfactant of the present invention, which is distributed by M-I L.L.C.

NOVAWET is surfactant distributed by M-I

All values associated with the formulations described below are grams unless otherwise specified.

### EXAMPLE 1

Two invert emulsions having a density of about 12.5 pounds per gallon and an oil to water ratio of about 85:15 were formulated as indicated below, the first with a alkaline reserve (lime) and the second not having an alkaline reserve:

Formulation:

| | 1 | 2 | |
|---|---|---|---|
| Finagreen BDMF | 194 | 194 | |
| Lime | 3.5 | 0 | |
| VG-Plus | 3 | 3 | |
| Ecogreen-P | 6 | 6 | |
| Ecogreen-S | 2 | 2 | |
| Ecogreen-F | 1 | 1 | |
| EMI 545 | 0 | 6 | |
| 20% CaCl₂ Brine | 54 | 54 | |
| Barite | 258 | 258 | |
| Acetic Acid | — | 1 | ml |

Samples of the above invert emulsions were heat aged at 250° F. for 16 hours. The rheological properties of the resulting fluids are given below:

Heat Aged for 16 H at 250° F.
Formulation

| | 1 | 2 |
|---|---|---|
| | (lime) | (no lime) |
| PV | * | 32 |
| YP | * | 9 |
| Gels | | |
| 10 sec. | * | 5 |
| 10 min. | * | 8 |
| ES | * | 923 |

*sample too thick to measure

One of ordinary skill in the art should appreciate upon review of the above data that the invert emulsion fluid conventionally formulated and containing lime (Formula 1) was too thick to measure after heat aging and thus would not be suitable for use as an invert emulsion drilling fluid. In contrast the invert emulsion drilling fluid formulated in accordance with the present invention exhibits properties of an invert emulsion that is suitable for use in drilling operations.

A sample of the invert emulsion drilling fluid formulated in accordance with the present invention (Formula 2) was heat aged at various temperatures to illustrate the wide range of temperatures, which can be withstood by the formulation. Such data is presented below:

Formulation:

| | 2 | 2 |
|---|---|---|
| | (no lime) | (no lime) |
| | Heat Aged for | Heat Aged for |
| | 16 H at 250° F. | 16 H at 275° F. |
| PV | 32 | 31 |
| YP | 9 | 10 |
| Gels | | |
| 10 sec. | 5 | 7 |
| 10 min. | 8 | 10 |
| ES | 923 | 589 |
| | Heat Aged for | Heat Aged for |
| | 16 H at 300° F. | 16 H at 350 |
| PV | 33 | 33 |
| YP | 6 | 15 |
| Gels | | |
| 10 sec. | 7 | 8 |
| 10 min. | 10 | 12 |
| ES | 687 | 900 |
| HTHP | | 4.8 |

Upon review of the above data, one of ordinary skill in the art should understand that the invert emulsion drilling fluid formulated in accordance with the present invention retains the properties necessary for its use as an invert emulsion drilling fluid at a wide range of temperatures.

The above drilling fluids after heat aging at 250° F. for 16 hours were analyzed for % alcohol in the fluid. The % alcohol indicates the extent of the hydrolysis of the ester component of the invert emulsion fluid.

| Formulation | | Alcohol Content |
|---|---|---|
| 1 | (lime) | 6.0% |
| 2 | (no lime) | 0.1% |

The above results indicated that the Finagreen BDMF fluid with reserve alkalinity had much higher hydrolysis than the fluid of this invention with negative alkalinity. Also, the results of heat aging indicated that the fluids with negative alkalinity are stable in excess of 350° F.

### EXAMPLE 2

The following invert emulsion fluids were formulated so as to give invert emulsions having a 12.5 pound per gallon density and an oil to water ratio of 85:15 as indicated below, the first with an alkaline reserve the second absent an alkaline reserve:

Formulation

| | 3 | 4 | |
|---|---|---|---|
| isopropyl meristate-ester | 194 | 194 | |
| Lime | 3.5 | 0 | |
| Gel | 3 | 3 | |
| Ecogreen-P | 6 | 6 | |
| Ecogreen-S | 2 | 2 | |
| Ecogreen-F | 1 | 1 | |
| EMI 545 | 0 | 6 | |
| 20% CaCl₂ Brine | 54 | 54 | |
| Barite | 258 | 258 | |
| Acetic Acid | — | 1 | ml |

The rheological properties of the resulting invert emulsion were measured both before and after heat aging and gave the following results:

| | Heat Aged for 16 h | | Heat Aged for 16 h at | | Heat Aged for 16 h at | | Heat Aged for 16 h at | |
|---|---|---|---|---|---|---|---|---|
| | at 250° F. | | 275° F. | | 300° F. | | 325° F. | |
| | Formulation | | | | | | | |
| | 3 | 4 | 3 | 4 | 3 | 4 | 3 | 4 |
| | (lime) | (no lime) | (lime) | (no lime) | (lime) | (no lime) | (lime) | (no lime) |
| PV | 28 | 21 | 34 | 22 | 58 | 22 | 61 | 21 |
| YP | 11 | 7 | 7 | 4 | 22 | 5 | 69 | 14 |
| Gels | | | | | | | | |
| 10 sec. | 9 | 5 | 5 | 4 | 11 | 4 | 35 | 5 |
| 10 min. | 13 | 9 | 10 | 7 | 19 | 7 | 41 | 11 |
| ES | 600 | 968 | 223 | 553 | 323 | 387 | 328 | 503 |
| HTHP | | | | | | | | 4.4 |

The above drilling fluids with isopropyl-meristate ester were analyzed for % alcohol content in the fluid after heat aging at 300° F. The % alcohol content serves as an indication of extent of the hydrolysis of the ester. The following results were obtained:

| Formulation | | Alcohol Content |
|---|---|---|
| 3 | Lime | 2% |
| 4 | No Lime | 0.1% |

The above results indicate that the fluid with reserve alkalinity has higher % hydrolysis than the fluid with negative alkalinity as is defined herein. Also, the fluids with negative alkalinity of this invention are stable in the excess of 325° F. heat aging cycle.

### EXAMPLE 3

The following invert emulsion drilling fluid was formulated utilizing a methyl ester of coco fatty acid to give an invert emulsion with an oil to water ratio of 85:15 and a density of 12.5 pounds per gallon as follows:

| | Formulation | |
|---|---|---|
| | 5 | |
| Methyl Ester of coco fatty acid | 194 | |
| Lime | 0 | |
| Gel | 3 | |
| Ecogreen-P | 6 | |
| Ecogreen-S | 2 | |
| Ecogreen-F | 1 | |
| EMI 545 | 6 | |
| 20% CaCl₂ Brine | 54 | |
| Barite | 258 | |
| Acetic Acid | 1 | ml |

The rheological properties of the resulting invert emulsion were measured both prior to and after heat aging giving the following results:

| | | Heat Aged for | Heat Aged for |
|---|---|---|---|
| | Initial | 16 h at 250° F. | 16 h at 300° F. |
| PV | 14 | 15 | 17 |
| YP | 9 | 5 | 9 |
| Gels | | | |
| 10 sec. | 8 | 5 | 7 |
| 10 min. | 11 | 8 | 9 |
| ES | 285 | 780 | 999 |
| HTHP | | | 10.4 |

The above formulation after heat aging at 300° F. showed 0.1% alcohol content in the fluid indicating the stability of the fluid in excess of 300° F. with negative alkalinity of this invention.

### EXAMPLE 4

The following invert emulsion that is illustrative of the present invention was formulated:

| | Formulation | |
|---|---|---|
| | 6 | |
| methyl oleate | 186 | |
| VG PLUS | 2 | |
| Ecogreen-P | 6 | |
| Ecogreen-S | 2 | |
| Ecogreen-F | 2 | |
| Acetic Acid | 1 | ml |
| EMI-545 | 6 | |
| 20% CaCl₂ Brine | 68 | |
| barite | 231 | |

The above components were mixed to form the invert emulsion in the following manner: a) the ester and VGPLUS were mixed together for 10 minutes; b) to this mixture the Ecogreen-P, Ecogreen-S, Ecogreen-F, acetic acid and EMI-545 were added and mixed for an additional 10 minutes; c) the brine was added with mixing and upon complete addition the mixing was continued for an additional 30 minutes to form an invert emulsion; d) the weight material (barite) was added and the fully formulated invert emulsion mud was stirred for an additional 10 minutes. The resulting invert emulsion drilling mud was found to have the following properties before and after heat aging at different temperatures:

| | | Heat Aged at | Heat Aged at | Heat Aged at |
|---|---|---|---|---|
| | Initial | 200° F. for 16 h | 250° F. for 16 h | 300° F. for 16 h |
| PV | 30 | 29 | 30 | 30 |
| YP | 10 | 17 | 20 | 14 |
| Gels | | | | |
| 10 sec. | 10 | 13 | 12 | 7 |
| 10 min. | 15 | 23 | 18 | 10 |
| ES | 1078 | 361 | 711 | 1443 |
| HTHP | | 6 | 2.8 | 1.6 |

Upon review of the above data, one of skill in the art should appreciate that the fluid formulated in accordance with this invention is stable and retains the properties of a useful invert emulsion drilling mud even after heat aging in excess of 300° F. Further it will be noted that there is no lime or other alkaline reserve present in the formulation and thus the invert emulsion drilling fluid is considered to posses negative alkalinity as the term is used in the present disclosure.

### EXAMPLE 5

The following invert emulsion is illustrative of the conventional manner of making invert emulsion drilling fluids was formulated:

| | Formulation |
|---|---|
| | 7 |
| methyl oleate | 186 |
| Lime | 3.5 |
| VG PLUS | 2 |
| Ecogreen-P | 6 |
| Ecogreen-S | 2 |
| Ecogreen F | 2 |
| 20% CaCl₂ Brine | 68 |
| Barite | 231 |

The above components were mixed to form the invert emulsion in the following manner: a) the ester, lime and VGPLUS were mixed together for 10 minutes; b) to this mixture the Ecogreen-P, Ecogreen-S, Ecogreen-F, were added and mixed for an additional 10 minutes; c) the brine was added with mixing and upon complete addition the mixing was continued for an additional 30 minutes to form an invert emulsion; d) the weight material (barite) was added and the fully formulated invert emulsion mud was stirred for an additional 10 minutes. The resulting invert emulsion drilling mud was found to have the following properties before and after heat aging at different temperatures:

| | | Heat Aged at | Heat Aged at | Heat Aged at |
|---|---|---|---|---|
| | Initial | 200° F. for 16 h | 250° F. for 16 h | 300° F. for 16 h |
| PV | 33 | 70 | 37 | 50 |
| YP | 29 | 106 | 25 | 28 |
| Gels | | | | |
| 10 sec. | 13 | 69 | 12 | 15 |
| 10 min. | 18 | 80 | 15 | 16 |
| ES | 1171 | 330 | 260 | 875 |
| HTHP | — | 2.8 | 2.4 | 5.2 |

Upon review of the above results one of ordinary skill in the art should appreciate that that an ester containing invert emulsion drilling fluid with excess alkalinity results in the hydrolysis of the ester and that upon heat aging at 200° F. the resulting mixture is not considered especially useful as a drilling fluid..

### EXAMPLE 6

The following invert emulsion that is illustrative of the present invention was formulated:

| | Formulation | |
|---|---|---|
| | 8 | |
| methyl oleate | 186 | |
| VG PLUS | 2 | |
| VERSACOAT | 6 | |
| VERSAWET | 2 | |
| Ecogreen-F | 2 | |
| Acetic Acid | 1 | ml |
| EMI-545 | 6 | |
| 20% CaCl₂ Brine | 68 | |
| Barite | 231 | |

The above components were mixed to form the invert emulsion in the following manner: a) the ester and VGPLUS were mixed together for 10 minutes; b) to this mixture the VERSACOAT, VERSAWET, Ecogreen-F, acetic acid and EMI-545 were added and mixed for an additional 10 minutes; c) the brine was added with mixing and upon complete addition the mixing was continued for an additional 30 minutes to form an invert emulsion; d) the weight material (barite) was added and the fully formulated invert emulsion mud was stirred for an additional 10 minutes. The resulting invert emulsion drilling mud was found to have the following properties before and after heat aging at different temperatures:

| | | Heat Aged at | Heat Aged at | Heat Aged at |
|---|---|---|---|---|
| | Initial | 200° F. for 16 h | 250° F. for 16 h | 300° F. for 16 h |
| PV | 29 | 28 | 32 | 31 |
| YP | 14 | 17 | 19 | 11 |
| Gels | | | | |
| 10 sec. | 15 | 12 | 11 | 7 |
| 10 min. | 37 | 17 | 18 | 8 |
| ES | 1257 | 875 | 875 | 1148 |
| HTHP | — | 6 | 2 | 2.4 |

Upon review of the above data one of ordinary skill in the art should appreciate that the above noted invert emulsion drilling fluid formulated in accordance with the present invention is stable and useful as a drilling fluid even after being heat aged at temperatures up to 300° C. This is in contrast to the invert emulsion drilling fluid in Example 6 in which the presence of an alkaline reserve cause the break down and premature aging of the invert emulsion fluid.

### EXAMPLE 7

The following invert emulsion that is illustrative of the present invention was formulated:

| | Formulation | |
|---|---|---|
| | 9 | |
| methyl oleate | 186 | |
| VG PLUS | 2 | |
| Ecogreen-P | 6 | |
| Ecogreen-S | 2 | |
| Ecogreen-F | 2 | |
| NOVAWET | 2 | |
| Acetic Acid | 1 | ml |
| EMI-545 | 6 | |
| 20% CaCl₂ Brine | 68 | |
| Barite | 231 | |

The above components were mixed to form the invert emulsion in the following manner: a) the ester and VGPLUS were mixed together for 10 minutes; b) to this mixture the Ecogreen-P, Ecogreen-S, Ecogreen-F, NOVAWET, acetic acid and EMI-545 were added and mixed for an additional 10 minutes; c) the brine was added with mixing and upon complete addition the mixing was continued for an additional 30 minutes to form an invert emulsion; d) the weight material (barite) was added and the fully formulated invert emulsion mud was stirred for an additional 10 minutes. The resulting invert emulsion drilling mud was found to have the following properties before and after heat aging at different temperatures:

| | | Heat Aged at | Heat Aged at | Heat Aged at |
|---|---|---|---|---|
| | Initial | 200° F. for 16 h | 250° F. for 16 h | 300° F. for 16 h |
| PV | 24 | 16 | 27 | 28 |
| YP | 7 | 14 | 12 | 15 |
| Gels | | | | |
| 10 sec. | 10 | 12 | 10 | 10 |
| 10 min. | 13 | 16 | 13 | 13 |
| ES | 712 | 867 | 719 | 618 |
| HTHP | — | 6.8 | 4.8 | 2.4 |

Upon review of the above data one of ordinary skill in the art should appreciate that the above noted invert emulsion drilling fluid formulated in accordance with the present invention is stable and useful as a drilling fluid even after being heat aged at temperatures up to 300° C. This is in contrast to the invert emulsion drilling fluid in Example 6 in which the presence of an alkaline reserve cause the break down and premature aging of the invert emulsion fluid.

### EXAMPLE 8

The following invert emulsion that is illustrative of the present invention was formulated:

| | Formulation | |
|---|---|---|
| | 10 | |
| methyl oleate | 186 | |
| VG PLUS | 2 | |
| Ecogreen-P | 6 | |
| Ecogreen-S | 2 | |
| Ecogreen-F | 2 | |
| Acetic Acid | 0 | ml |
| EMI-545 | 3 | |
| 20% CaCl₂ Brine | 68 | |
| Barite | 231 | |

The above components were mixed to form the invert emulsion in the following manner: a) the ester and VGPLUS were mixed together for 10 minutes; b) to this mixture the Ecogreen-P, Ecogreen-S, Ecogreen-F, NOVAWET, and EMI-545 were added and mixed for an additional 10 minutes; c) the brine was added with mixing and upon complete addition the mixing was continued for an additional 30 minutes to form an invert emulsion; d) the weight material (barite) was added and the fully formulated invert emulsion mud was stirred for an additional 10 minutes. The resulting invert emulsion drilling mud was found to have the following properties before and after heat aging at different temperatures:

| | | Heat Aged at | Heat Aged at | Heat Aged at |
|---|---|---|---|---|
| | Initial | 200° F. for 16 h | 250° F. for 16 h | 300° F. for 16 h |
| PV | 25 | 28 | 28 | 29 |
| YP | 11 | 17 | 16 | 7 |
| Gels | | | | |
| 10 sec. | 9 | 11 | 10 | 5 |
| 10 min. | 13 | 13 | 12 | 7 |
| ES | 1210 | 867 | 851 | 953 |
| HTHP | — | 3.2 | 1.6 | 2 |

Upon review of the above data one of ordinary skill in the art should appreciate that the above noted invert emulsion drilling fluid formulated in accordance with the present invention is stable and useful as a drilling fluid even after being heat aged at temperatures up to 300° C. This is in contrast to the invert emulsion drilling fluid in Example 6 in which the presence of an alkaline reserve cause the break down and premature aging of the invert emulsion fluid.

### EXAMPLE 9

The following invert emulsion mud that is illustrative of the present invention was formulated so as to have a density of 14 pounds-per gallon and an oil:water ratio of 85:15:

| | Formulation | |
|---|---|---|
| | 11 | |
| methyl oleate | 191 | |
| VG PLUS | 5 | |
| VERSALIG | 6 | |
| EMI-545 | 12 | |
| 20% CaCl₂ Brine | 51 | |
| Barite | 340 | |
| Acetic Acid | 2 | ml |

The Theological properties of a first portion of the resulting invert emulsion were measured both before and after heat aging and gave the following results:

| | | Heat Aged at |
|---|---|---|
| | Initial | 200° F. for 15 h |
| PV | 26 | 25 |
| YP | 7 | 11 |
| Gels | | |
| 10 sec. | 7 | 7 |
| 10 min. | 16 | 10 |
| ES | 952 | 1054 |
| HTHP | — | 6 |

To a second portion of the above formulated was added NOVATHIN at a concentration of 5 lb per barrel. After though mixing, the resulting invert emulsion formed and had the following rheological properties before and after heat aging:

| | After Addition | Heat Aged at |
|---|---|---|
| | of NOVATHIN | 250° F. for 15 h |
| PV | 25 | 24 |
| YP | 12 | 12 |
| Gels | | |
| 10 sec. | 9 | 7 |
| 10 min. | 12 | 10 |
| ES | — | 1499 |
| HTHP | — | 4.8 |

Upon review by one of skill in the art, the above results should indicate that the addition of supplemental surfactants, such as NOVATHIN can be added to the invert emulsions of the present invention without deleterious effect.

### EXAMPLE 10

The following invert emulsion mud that is illustrative of the present invention was formulated so as to have a density of 12 pounds-per gallon and an oil:water ratio of 80:20:

| Formulation | 12 |
|---|---|
| methyl oleate | 186 |
| VG PLUS | 2 |
| VERSALIG | 6 |
| EMI 545 | 12 |
| 20% CaCl₂ Brine | 68 |
| Barite | 231 |
| Acetic Acid | 2 ml |

The rheological properties of a first portion of the resulting invert emulsion were measured both before and after heat aging and gave the following results:

| | | Heat Aged at |
|---|---|---|
| | Initial | 200° F. for 15 h |
| PV | 21 | 23 |
| YP | 5 | 4 |
| Gels | | |
| 10 sec. | 3 | 3 |
| 10 min. | 13 | 2 |
| ES | 1451 | 704 |
| HTHP | — | 4.8 |

To a second portion of the above formulated invert emulsion supplemental surfactant EMI-524 was added in a concentration of about 5 lb per barrel. The rheological properties of the resulting invert emulsion were measure both before and after heat aging to give the following results:

| | After Addition | Heat Aged at |
|---|---|---|
| | of EMI-524 | 250° F. for 15 h |
| PV | 24 | 24 |
| YP | 12 | 6 |
| Gels | | |
| 10 sec. | 8 | 4 |
| 10 min. | 11 | 6 |
| ES | — | 485 |
| HTHP | — | 2.8 |

Upon review by one of skill in the art, the above results should indicate that the addition of supplemental surfactants, such as EMI-524 may be added to the invert emulsions of the present invention without deleterious effect.

### EXAMPLE 11

The following invert emulsion mud that is illustrative of the present invention was formulated so as to have a density of 14 pounds-per gallon and an oil:water ratio of 85:15:

| Formulation | 13 |
|---|---|
| methyl oleate | 191 |
| VG PLUS | 5 |
| Ecogreen-F | 1.5 |
| EMI-545 | 12 |
| 20% CaCl₂ Brine | 51 |
| Barite | 340 |
| Acetic Acid | 2 ml |

The rheological properties of a first portion of the resulting invert emulsion were measured both before and after heat aging and gave the following results:

| | | Heat Aged at |
|---|---|---|
| | Initial | 200° F. for 15 h |
| PV | 47 | 40 |
| YP | 27 | 26 |
| Gels | | |
| 10 sec. | 20 | 16 |
| 10 min. | 37 | 28 |
| ES | 968 | 1202 |
| HTHP | — | 4 |

To a second portion of the above formulated invert emulsion supplemental surfactant Ecogreen-S was added in a concentration of about 5 lb per barrel. The rheological properties of the resulting invert emulsion were measure both before and after heat aging to give the following results:

| | After addition of | Heat Aged at |
|---|---|---|
| | Ecogreen-S | 250° F. for 15 h |
| PV | 36 | 32 |
| YP | 24 | 12 |
| Gels | | |
| 10 sec. | 13 | 8 |
| 10 min. | 27 | 10 |
| ES | — | 976 |
| HTHP | — | .80 |

Upon review by one of skill in the art, the above results should indicate that the addition of supplemental surfactants, such as Ecogreen-S may be added to the invert emulsions of the present invention without deleterious effect.

### EXAMPLE 12

The following invert emulsion mud that is illustrative of the present invention was formulated so as to have a density of 14 pounds-per gallon and an oil:water ratio of 90:10:

| Formulation | 14 |
|---|---|
| methyl oleate | 189 |
| VG PLUS | 3 |
| Ecogreen-P | 6 |
| Ecogreen-S | 2 |
| Ecogreen-F | 1 |
| NOVA WET | 2 |
| EMI-545 | 6 |
| 20% CaCl₂ Brine | 31 |
| Barite | 349 |
| Acetic Acid | 1 ml |

The rheological properties of the resulting invert emulsion were measured both before and after heat aging and gave the following results:

| | | Heat Aged for | Heat Aged for | Heat Aged for |
|---|---|---|---|---|
| | Initial | 16 h at 250° F. | 16 h at 300° F. | 16 h at 350 ° F. |
| PV | 18 | 26 | 28 | 36 |
| YP | 4 | 7 | 6 | 14 |
| Gels | | | | |
| 10 sec. | 4 | 5 | 6 | 9 |
| 10 min. | 7 | 7 | 9 | 11 |
| ES | 851 | 1218 | 1435 | 1143 |

Upon review of the above Example, one of ordinary skill in the art would appreciate that the data presented shows that the fluids of this invention, all of which are absent an alkaline reserve, are stable when subjected to heat aging at temperatures up to about 300° F. Further such a person would understand that the fluids made in accordance wit the present invention remain useful as drilling fluids for periods of time significantly longer than ester based invert emulsion drilling fluids, which have an alkaline reserve.

### EXAMPLE 13

The following invert emulsion muds are illustrative of the present invention and were formulated so as to have a density of 14 pounds-per gallon and an oil:water ratio of 90:10:

| Formulation | 15 | 16 | 17 |
|---|---|---|---|
| methyl ester | 186 | 186 | 186 |
| (7060 Radia) | | | |
| lime | 0 | 0 | 3.5 |
| VG PLUS | 2 | 2 | 2 |
| Ecogreen-P | 6 | 6 | 6 |
| Ecogreen-S | 2 | 2 | 2 |
| Ecogreen-F | 2 | 2 | 2 |
| Armac HT | 0 | 6 | 0 |
| 20% CaCl₂ Brine | 68 | 68 | 68 |
| Barite | 231 | 231 | 231 |
| Acetic Acid | 2 | 2 | 0 |

The rheological properties of the resulting invert emulsions were measured both before and after heat aging and gave the following results:

| | | |
|---|---|---|
| Heat Aged | Heat Aged | Heat Aged |
| for 1 h | for 16 h | for 16 h |
| at 150° F. | at 250° F. | at 350° F. |

Mud 15

| | | | | |
|---|---|---|---|---|
| PV | | 30 | 28 | 28 |
| YP | | 17 | 13 | 11 |
| Gels | 10 sec. | 11 | 7 | 6 |
| | 10 min. | 13 | 9 | 8 |
| ES | | 568 | 209 | 208 |
| API FL | | 1 | 0.6 | 1 |

Mud 16

| | | | | |
|---|---|---|---|---|
| PV | | 25 | 25 | 27 |
| YP | | 10 | 16 | 16 |
| Gels | 10 sec. | 10 | 10 | 9 |
| | 10 min. | 14 | 14 | 11 |
| ES | | 1097 | 397 | 186 |
| API FL | | 3.6 | 2.8 | 0.4 |

Mud 17

| | | | | |
|---|---|---|---|---|
| PV | | 33 | ** | ** |
| YP | | 24 | ** | ** |
| Gels | 10 sec. | 13 | ** | ** |
| | 10 min. | 16 | ** | ** |
| ES | | 430 | ** | ** |
| API FL | | 2.8 | ** | ** |

Note: ** indicates mud was too thick to measure properties.

Upon review of the above Example, one of ordinary skill in the art would appreciate that the data presented shows that drilling fluids may be formulated in accordance with this invention having negative alkalinity. That is to say drilling fluids can be formulated absent an alkaline reserve, and such fluids are stable when subjected to heat aging at temperatures up to about 300° F. Further such a person would understand that the fluids made in accordance with the present invention remain useful as drilling fluids for periods of time significantly longer than ester based invert emulsion drilling fluids, which have an alkaline reserve.

### EXAMPLE 14

The following invert emulsion muds that is illustrative of the present invention were formulated so as to have a density of 14 pounds-per gallon and an oil:water ratio of 90:10:

| Formulation | 18 | 19 |
|---|---|---|
| methyl ester | 186 | 186 |
| (7060 Radia) | | |
| VG PLUS | 2 | 2 |
| Ecogreen-P | 6 | 6 |
| Ecogreen-S | 2 | 2 |
| Ecogreen-F | 2 | 2 |
| Armac HT | 0 | 2 |
| 20% CaCl₂ Brine | 68 | 68 |
| Barite | 231 | 231 |
| Acetic Acid | 2 | 2 |

The rheological properties of the resulting invert emulsions were measured and were measured again after addition of acetic acid and further heat aging giving the following results:

| | | | |
|---|---|---|---|
| | Addition of | Addition of | |
| | 2 ml Acetic | 2 ml Acetic | |
| | Acid & Heat | Acid & Heat | |
| Heat Aged | Aged for | Aged for | Heat Aged |
| for 4 | 16 h at | 16 h at | for 16 h at |
| h at 150° F. | 250° F. | 325° F. | 350° F. |

Mud 18

| | | | | | |
|---|---|---|---|---|---|
| PV | | 30 | 27 | 35 | 40 |
| YP | | 19 | 14 | 11 | 5 |
| Gels | 10 sec. | 12 | 7 | 6 | 3 |
| | 10 min. | 14 | 11 | 10 | 5 |
| ES | | 784 | 241 | 722 | 421 |
| API FL | | — | 0.60 | 2.0 | 3.2 |

Mud 19

| | | | | | |
|---|---|---|---|---|---|
| PV | | 25 | 25 | 28 | 35 |
| YP | | 7 | 8 | 13 | 10 |
| Gels | 10 sec. | 9 | 9 | 8 | 5 |
| | 10 min. | 13 | 12 | 6 | 3 |
| ES | | 1085 | 440 | 500 | 516 |
| API FL | | 0 | 1.4 | 0.4 | 6.0 |

Upon review of the above Example, one of ordinary skill in the art would appreciate that the data presented shows that aqueous acidic solutions may be added to the drilling fluids of the present invention and that such fluids are stable when subjected to heat aging at temperatures up to about 350° F. Further such a person would understand that the fluids made in accordance with the present invention remain useful as drilling fluids despite the inclusion of acidic components in the drilling fluid.

In view of the preceding, one of ordinary skill in the art should understand and appreciate that in one illustrative embodiment of the present invention an invert emulsion drilling fluid includes: an oleaginous phase a non-oleaginous phase an emulsifying agent capable of stabilizing an invert emulsion drilling fluid under conditions of negative alkalinity and wherein the drilling fluid has negative alkalinity. The non-oleaginous phase may be selected from fresh water, sea water, brine, aqueous solutions containing water soluble organic salts, water soluble alcohols or water soluble glycols or combinations thereof. The emulsifying agent should be capable of stabilizing the invert emulsion when the non-oleaginous phase is an aqueous acidic solution and preferably the addition of an aqueous acidic solution to the invert emulsion should not cause the invert emulsion to break. In one preferred embodiment the non-oleaginous phase has an hydroxide ion concentration of less than 1×10⁻⁸ moles per liter. Suitable emulsifying agents may be selected from the group consisting of: imidazoline, amidoamines of fatty acids, tall oil fatty acids, and protonated amines having the structure

[R—N⁺—H₃] B⁻

wherein R is a C₁₂-C₂₂ alkyl group or a C₁₂-C₂₂ alkenyl group and B— is a conjugate base of an acid, and preferably the emulsifying agent comprises from about 0.1 to about 10.0 percent by weight to volume of said drilling fluid. The oleaginous fluid utilized in the present illustrative embodiment may be selected from diesel oil, mineral oil, synthetic oil, ester oils, glycerides of fatty acids, aliphatic esters, aliphatic ethers, aliphatic acetals, or other such hydrocarbons and combinations thereof. In one illustrative embodiment a majority of the oleaginous fluid may include esters of C₁-C₁₂ alcohols and C₈-C₂₄ monocarboxylic acids and preferably the esters may be selected from C₁ to C₁₂ alkyl alcohol esters of oleic acid, C₁ to C₁₂ alkyl alcohol esters of myristic acid, C₁ to C₁₂ alkyl alcohol ester of coco fatty acid, and mixtures thereof. In the present illustrative embodiment the drilling fluid may further include a weighting agent such as barite, calcite, mullite, gallena, manganese oxides, iron oxides, or combinations thereof.

Another illustrative embodiment of the present invention includes a mineral-oil free invert emulsion drilling fluid including: an oleaginous phase comprising substantially of esters of C₁-C₁₂ alcohols and C₈-C₂₄ monocarboxylic acids; an non-oleaginous phase; and an emulsifying agent, said emulsifying agent being in sufficient amounts to stabilize an invert emulsion and wherein the mineral oil-free invert emulsion drilling fluids has negative alkalinity. The illustrative drilling fluid should not break upon the addition of an aqueous acidic solution to the invert emulsion and preferably the non-oleaginous phase may have a hydroxide ion concentration of less than 1×10⁻⁸ moles per liter. That is to say the emulsifying agent should be capable of stabilizing the invert emulsion in the absence of an alkali reserve. Preferably the emulsifying agent may be selected from the group consisting of: imidazoline, amidoamines of fatty acids, tall oil fatty acids, and protonated amines having the structure

[R—N⁺—H₃] B⁻

wherein R is a C₁₂-C₂₂ alkyl group or a C₁₂-C₂₂ alkenyl group and B— is a conjugate base of an acid. Preferably the ester is selected from C₁ to C₁₂ alkyl alcohol esters of oleic acid, C₁ to C₁₂ alkyl alcohol esters of myristic acid, C₁ to C₁₂ alkyl alcohol ester of coco fatty acid, and mixtures thereof. The illustrative drilling fluid may further include weighting agents such as barite, mullite, gallena, manganese oxides, iron oxides, or combinations thereof. The non-oleaginous phase may preferably be selected from fresh water, sea water, brine, aqueous solutions containing water soluble organic salts, water soluble alcohols or water soluble glycols or combinations thereof.

The present invention also includes the use of the drilling fluids disclosed herein. Thus one of ordinary skill in the art should appreciate that a method of drilling a subterranean well with an invert emulsion drilling fluid is within the scope of the present invention. One such method may include: formulating an invert emulsion drilling fluid such that the drilling fluid includes, an oleaginous phase; a non-oleaginous phase; an emulsifying agent, wherein said emulsifying agent is capable of stabilizing the invert emulsion when said drilling fluid has a negative alkalinity; and drilling said well with said invert emulsion drilling fluid.

While the compositions and methods of this invention have been described in terms of preferred and illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. An invert emulsion drilling fluid comprising:
an oleaginous phase
a non-oleaginous phase
an emulsifying agent capable of stabilizing an invert emulsion drilling fluid under conditions of negative alkalinity, and
wherein said invert emulsion drilling fluid has negative alkalinity.

2. The drilling fluid of claim 1 wherein said emulsifying agent is capable of stabilizing the invert emulsion when the non-oleaginous phase is an aqueous acidic solution.

3. The drilling fluid of claim 1 wherein the addition of an aqueous acidic solution to the invert emulsion does not cause the invert emulsion to break.

4. The drilling fluid of claim 1 wherein the non-oleaginous phase has a hydroxide ion concentration of less than 1×10⁻⁷ moles per liter.

5. The drilling fluid of claim 1 wherein said emulsifying agent is selected from the group consisting of: imidazoline, amidoamines of fatty acids, tall oil fatty acids, and protonated amines having the structure
[R—N⁺—H₃] B⁻
wherein R is a C₁₂-C₂₂ alkyl group or a C₁₂-C₂₂ alkenyl group and B— is a conjugate base of an acid

6. The drilling fluid of claim 5 wherein the R group on the protonated amine emulsifier is selected from straight or branched dodecyl, tridecyl, tetradecyl, pentadecyl, hexadecyl, heptadecyl, octadecyl, nodecyl, eicosyl, heneicosyl, docosyl, mixtures and unsaturated derivatives thereof.

7. The drilling fluid of claim 5 wherein the counter ion (B⁻) of the protonated amine is conjugate base of an aqueous acid is selected from sulfuric acid, nitric acid, hydrofluoric acid, hydrochloric acid, phosphoric acid, boric acid, citric acid, acetic acid, formic acid, benzoic acid, salicyclic acid, oxalic acid, glycolic acid, lactic acid, glutaric acid, halogenated acetic acids, organosulfonic acids, organophosphoric acids and compounds that generate acidic solutions upon dissolution in water selected from acetic anhydride, hydrolyzable esters, hydrolyzable organosulfonic acid derivatives, hydrolyzable organophosphoric acid derivatives, phosphorus trihalide, phosphorous oxyhalide, acidic metal salts, sulfur dioxide, nitrogen oxides, carbon dioxide, and combinations of these.

8. The drilling fluid of claim 1, wherein the emulsifying agent comprises from about 0.1 to about 10.0 percent by weight to volume of said drilling fluid.

9. The drilling fluid of claim 1 wherein the oleaginous fluid is selected from diesel oil, mineral oil, synthetic oil, ester oils, glycerides of fatty acids, aliphatic esters, aliphatic ethers, aliphatic acetals, and combinations thereof.

10. The drilling fluid of claim 1 wherein a majority of the oleaginous fluid comprises of esters of C₁-C₁₂ alcohols and C₈-C₂₄ monocarboxylic acids.

11. The drilling fluid of claim 9 wherein the ester is selected from C₁ to C₁₂ alkyl alcohol esters of oleic acid, C₁ to C₁₂ alkyl alcohol esters of myristic acid, C₁ to C₁₂ alkyl alcohol ester of coco fatty acid, and mixtures thereof.

12. The drilling fluid of claim 1 further comprising a weighting agent, said weighting agent being selected from barite, calcite, mullite, gallena, manganese oxides, iron oxides, or combinations thereof.

13. The drilling fluid of claim 1 wherein the non-oleaginous phase is selected from fresh water, sea water, brine, aqueous solutions containing water soluble organic salts, water soluble alcohols or water soluble glycols or combinations thereof.

14. A mineral-oil free invert emulsion drilling fluid comprising
an oleaginous phase comprising substantially of esters of C₁-C₁₂ alcohols and C₈-C₂₄ monocarboxylic acids;
an non-oleaginous phase;
an emulsifying agent, said emulsifying agent being in sufficient amounts to stabilize an invert emulsion, and
wherein said mineral oil-free invert emulsion drilling fluid has negative alkalinity.

15. The drilling fluid of claim 14 wherein the addition of an aqueous acidic solution to the invert emulsion does not cause the invert emulsion to break.

16. The drilling fluid of claim 14 wherein the non-oleaginous phase has an hydroxide ion concentration of less than 1×10⁻⁷ moles per liter.

17. The drilling fluid of claim 14 wherein said emulsifying agent is capable of stabilizing the invert emulsion in the absence of an alkali reserve.

18. The drilling fluid of claim 14 wherein the ester is selected from C₁ to C₁₂ alkyl alcohol esters of oleic acid, C₁ to C₁₂ alkyl alcohol esters of myristic acid, C₁ to C₁₂ alkyl alcohol ester of coco fatty acid, and mixtures thereof.

19. The drilling fluid of claim 18 further comprising a weighting agent, said weighting agent being selected from barite, mullite, gallena, manganese oxides, iron oxides, or combinations thereof.

20. The drilling fluid of claim 19 wherein the non-oleaginous phase is selected from fresh water, sea water, brine, aqueous solutions containing water soluble organic salts, water soluble alcohols or water soluble glycols or combinations thereof.

21. The drilling fluid of claim 14 wherein said emulsifying agent is selected from the group consisting of: imidazoline, amidoamines of fatty acids, tall oil fatty acids, and protonated amines having the structure
[R—N⁺—H₃] B⁻
wherein R is a C₁₂-C₂₂ alkyl group or a C₁₂-C₂₂ alkenyl group and B— is a conjugate base of an acid.

22. An invert emulsion drilling fluid comprising:
an oleaginous fluid;
a non-oleaginous fluid; and
a surfactant agent capable of stabilizing an invert emulsion under conditions of negative alkalinity
wherein said invert emulsion drilling fluid is absent an alkaline reserve.

23. An invert emulsion drilling fluid comprising:
an oleaginous fluid;
a non-oleaginous fluid, wherein said non-oleaginous fluid has a hydroxide concentration less than 1×10⁻⁷ moles per liter; and
an emulsifying agent capable of stabilizing the invert emulsion.

24. A method of drilling a subterranean well with an invert emulsion drilling fluid comprising:
formulating an invert emulsion drilling fluid having negative alkalinity such that the drilling fluid includes, an oleaginous phase; a non-oleaginous phase; an emulsifying agent, wherein said emulsifying agent is capable of stabilizing the invert emulsion when said drilling fluid has a negative alkalinity; and
drilling said well with said invert emulsion drilling fluid.
